(19) United States
(12) Patent Application Publication
(10) Pub. No.: US 2007/0075920 A1
(43) Pub. Date: Apr. 5, 2007

(54) Lcd viewing system

(76) Inventor: Charles Nicolas Granville Charlesworth, Newcastle-Upon-Tyne (GB)

Correspondence Address: NIXON PEABODY LLP - PATENT GROUP, CLINTON SQUARE, P.O. BOX 31051, ROCHESTER, NY, 14603-1051, US

(21) Appl. No.: 10/574,458

(22) PCT Filed: Oct. 4, 2004
(86) PCT No.: PCT/GB04/04203

§ 371 Date: Sep. 1, 2006

(30) Foreign Application Priority Data
Oct. 4, 2003 (GB) 0323266.7

(51) Int. Cl. G09G 5/00

(52) U.S. Cl. 345/9

(57) ABSTRACT

A viewing device for viewing a video display on a display screen comprising the sequential display of right and left images of a video stereo pair, said viewing device including first and second spaced viewing structures positioned in front of the viewer's eyes, each structure alternating between viewing and masking conditions, and wherein reference images or markers are included in the video sequence which can be detected by an optical sensor for synchronisation of the conditions of the viewing structures with the images on the display screen.

The invention to which this application relates is an apparatus and a method for assigning and synchronising the viewing of frames of still or moving images, hereinafter referred to in a non-limiting manner as video, which is generated from data and which frames are shown in a pre-designated sequence, typically for the viewing of Stereo 3D images.

The use of the display of frames of alternating right and left hand images of video on a single display screen viewed with a set of LCD shutter glasses which have spaced viewing apertures for the user's eyes and which are provided with controllable shutters such as those generated using LCD, to generate the appearance of a 3-dimensional image, is well known. The video can be moving images or still but, in any case, the single display screen is controlled to show a sequence of image frames. The normal sequence of display for viewing images with LCD shutter glasses is to show alternating right and left-hand image frames of a stereo pair with a typical frame rate of 25 or 30 frames per second of each right or left image.

LCD shutter viewing glasses are typically known as shutter glasses. This means that with the display screen showing alternating right and left-hand images of a stereo pair, the shutter glasses can be provided with shutters for the left and right eye viewing structures of the glasses with the shutters being activated with the aim of activating the left eye shutter when a right image is displayed such that the right eye only ever sees right images and activating the right eye shutter when a left image is displayed such that the left eye only ever sees left images.

One known form of providing shutters is to make the left and right frames of the glasses LCD screens and then activating the LCD screen such that the film of the LCD becomes opaque, hence acting as a shutter. The particular type of LCD film, which is typically laminated between two sheets of a transparent medium, can be selected to become substantially opaque when activated and therefore act as a shutter.

In order to activate the LCD mechanism to become a shutter, a voltage is typically applied to the LCD film and the control of the voltage is required to be in sequence to selectively activate the LCD between the left and right-hand viewing structures of the glasses as appropriate. Known methods of controlling the sequential application of the voltage are to provide a trigger mechanism which include wire, RF or IR links to the display screen, or its related image generator, typical of which is a personal computer, on which the right and left-hand video images are being displayed. However, these trigger methods, can be bulky when produced on the glasses and can lead to the activation of the LCD screens being out of sequence with the display of the left and right video images on the display screen. Once out of sequence, the desired result is not achieved for the person viewing the 3D images and therefore the apparatus as a whole is deemed not to be working in the desired manner. Furthermore additional hardware needs to be provided to the image generator in order to generate the triggering signal.

In a first aspect of the invention, there is provided a viewing device for viewing a video display on a display screen which display includes the sequential display of right and left video images, said viewing device including first and second, spaced, viewing structures, such that a first viewing structure is positioned in front of the viewer's left eye and a second viewing structure is positioned in front of the viewer's right eye with the viewer being required to look through the structures to view the video display, each structure provided to be operable to change between a viewing condition and a masking condition and characterised in that a feature of a predefined format is displayed in the sequence of video images which can be detected to allow synchronisation of the operation of the viewing structures and the display of the images on the display screen.

In one embodiment each viewing structure includes an LCD mechanism with a screen which is movable between substantially opaque and transparent conditions.

In one embodiment the device is provided to be worn.

In a further aspect of the invention there is provided a viewing device for viewing a sequential display of right and left video images to generate a three dimensional effect, said viewing device including first and second, spaced, viewing structures such that, in use, a first viewing structure is positioned in front of the viewer's left eye and a second viewing structure is positioned in front of the viewer's right eye with the viewer being required to look through the structures to view the video display, each structure provided with an LCD screen and control means to change the LCD screen between substantially transparent and substantially opaque conditions and wherein at least one feature of a predefined format is displayed and is of a form which can be detected by a sensor and allows synchronisation of the viewing device operation with the display of the images on the display screen.

In one embodiment the predefined format of the image is substantially black with a predefined marking element. In one embodiment the marking element is one or more white lines.

In one embodiment the sensor is mounted on the viewing device.

In an alternative embodiment, the predefined format of the image is a reference element overlaid onto an existing image.

Typically the reference element is located in a corner of the image to minimise interference of the same.

In one embodiment, the predefined image or reference element is generated at time intervals. The predefined images or reference elements can be generated or inserted at any time and with any frequency to suit particular viewing requirements.

In one embodiment the predefined image replaces the right or left hand image of an image pair.

In a preferred embodiment, the viewing device which is worn on the person, includes an optical sensor, or an optical sensor is connected thereto, and said optical sensor is provided to detect the display of the said predefined image and/or reference element.

In one embodiment, the optical sensor is in the form of a photodiode.

Typically the optical sensor is detachably mounted to the viewing device by any or any combination of reusable adhesive, clamps, grips, clips, screws, hook and loop fastenings, and/or the like.

The optical sensor and/or the viewing structures may be powered by any or any combination of batteries, mains power, and/or the like.

Typically the optical sensor is housed in a manner such that, when the person wearing the device is viewing the display screen, the optical sensor will automatically be positioned so as to directly face the same display screen. This ensures that the accurate detection of the predefined image and/or reference element in the video display is achieved. Typically the optical sensor housing is suitable for front or rear image projection.

Typically the display screen is any or any combination of Cathode Ray Tubes (CRTs), Plasma Screens, Organic Light Emitting Diodes (OLEDs), projectors, Liquid Crystal Displays (LCDs) and/or the like.

In one embodiment, the optical sensor includes a lens or other mechanism which acts to focus or direct the light generated by the display screen onto the optical sensor and/or reduce the field of view of the optical sensor to eliminate or reduce the possibility of adverse light effects provided from any other light sources.

Typically, the reference element covers a greater area than the area scanned by the optical sensor.

Typically, the data from the optical sensor is processed to provide a control signal generated whenever a predefined image and/or reference element is detected on the display screen.

Typically the optical sensor communicates with the viewing device using any or any combination of wires, optical means, radio frequencies, infra-red, and/or the like.

The control signal is used to identify a right or left image, depending on whether a right or left image is known to appear after the predefined image or in association with a reference element.

Typically the reference element is a distinguishing colour and/or shape to distinguish between left and white frames. In one embodiment the reference element for the right-hand frame is a white circle, and the reference element for the left-hand frame is a black circle.

The ability to identify positively that a right or left image is displayed at the particular time, allows the operation of the viewing device to be checked to ensure that the activation of the appropriate LCD mechanism shutter for the right or left viewing structure, is synchronised with the display of the right or left image frames.

In one embodiment the predefined image is generated in such a manner as to be consciously invisible to the majority of users.

In one embodiment the output of the optical sensor is used to determine the display rate of each successive video frame and using this output control the activation timing and frequency of the LCD shutter.

In one embodiment the electronic circuits associated with processing the signal output will act in a predictive and self-correcting manner to determine the activation timing and frequency of the LCD shutter.

For example, if over time, there is a drift in the operation of the LCD mechanism in comparison with the display of the video image frames, the generation of the predefined image, and detection of the same, allows the operation of the right and left LCD mechanisms to be brought back into synchronicity with the display of the right and left images. Furthermore, in addition to bringing the operation of the LCD mechanisms back into synchronicity for right and left hand images the control system for the viewing device can also be used to determine the ongoing requirement for speed of operation of the right and left LCD mechanisms and the length of activation.

Typically the operation of the viewing apparatus can be controlled to switch as required between registration on the display of a right-hand video image or left-hand video image.

Typically an adjustment mechanism is provided to allow the operation of the viewing apparatus to be micro-controlled, to adjust for variations in the speed of reaction or otherwise of the control signal to the displayed frames so as to bring the operation of the timing of the open and closed times of the shutters into exact time and/or phase of the frames on the viewing display.

Typically the adjustment mechanism is in the form of one or more wheels to allow fine tuning of the synchronisation of one or both viewing structures.

In a further aspect of the invention there is provided a method for viewing a series of left and right video images to create to the user a three-dimensional effect, said method comprising the steps of;
generating a sequence of left and right video images on a display screen;
placing a viewing device between the user's eyes and the display screen, said device including viewing structures for the user's left and right eye respectively;
operating each of the viewing structures to move between open and masked conditions to allow selective viewing of the video images in sequence with the display of the same; and
wherein the video images include at least one feature of a predefined format which can be detected by a sensor and, when detected, the same is used to check and, if required, alter the synchronicity between the operation of the viewing structures and the display of the video images.

The specific embodiment of the invention will now be described with reference to the accompany drawings, wherein:—

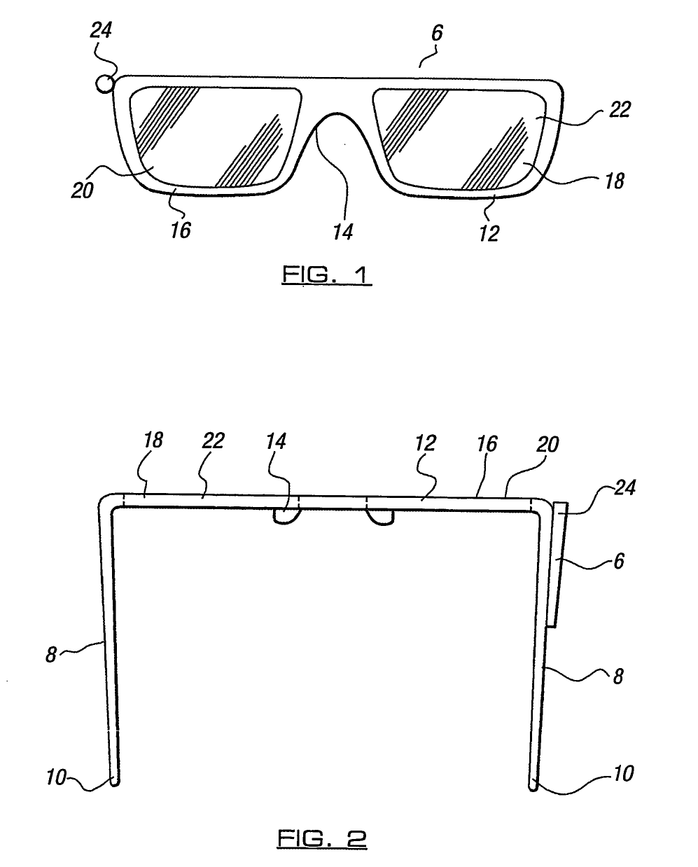

FIG. 1 illustrates a front elevation of the viewing device;

FIG. 2 illustrates a plan view of the viewing device according to FIG. 1 in the first embodiment;

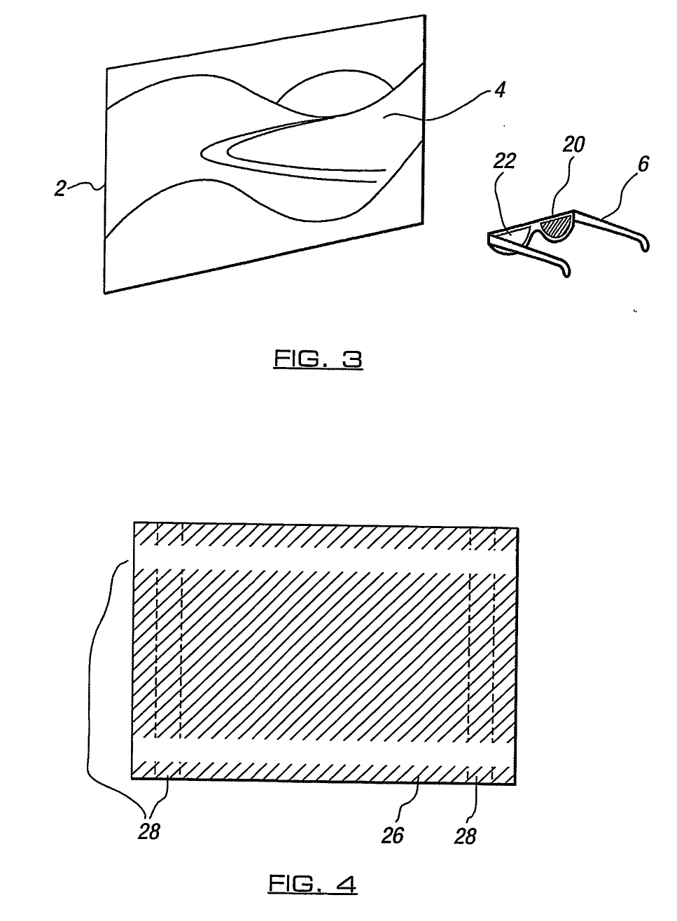

FIG. 3 illustrates the apparatus of the system as a whole; and

FIG. 4 illustrates one example of an image which can be used as a reference in accordance with the invention.

One embodiment of the invention is now described with reference to the accompanying drawings and, in particular, starting with FIG. 3, there is illustrated the apparatus and system in accordance with one embodiment of the invention. The apparatus comprises a display screen 2 on which the video images 4 are displayed to the user. The video images can be generated by processing means provided in connection with the display screen such as for example by a television or monitor or alternatively, can be generated by apparatus remote to the display screen and projected onto the screen such as for example in a cinema, projection television systems or the like.

In whichever embodiment, the video images are provided on the screen, the viewing procedure is the same in that a viewer of the display screen is provided with a viewing device 6. The viewing device is described in more detail in FIGS. 1 and 2 but basically allows the viewing of left and right stereo pairs of images displayed on the display screen to provide a 3-dimensional effect to be created for a viewer wearing the viewing device.

The viewing device is described in more detail in FIGS. 1 and 2 and can be seen to comprise arms 8, typically to be worn at the free ends 10, on the ears. The front face 12 has a bridge portion 14 to be worn at the nose and first and second viewing structures, 16, 18 each of said structures spaced apart from the other and positioned so as to be positioned in front of one of the eyes of the viewer when wearing the device thereby providing a right viewing aperture 20 and left viewing aperture 22. The apertures in each of the viewing structures, are fitted with an LCD display mechanism, said LCD display configuration can be of any conventional form and typically comprises front and rear layers of glass, plastic or other suitable transparent material and, disposed between said layers, an LCD film. Electrical contact means to the LCD display mechanisms allow the activation and control of the same. The LCD display conditions are changeable between substantially transparent and substantially opaque conditions as seen in FIG. 3 where the right structure 20 is opaque and the left hand structure 22 is transparent. The application of a voltage to the LCD display typically causes the same to move to the substantially opaque condition and, when in that condition, the viewer's eye at that particular viewing structure, cannot see through the same such that only the other eye looking through the other viewing structure which is in a substantially transparent condition can see the image on the video display. Thus, it will be apparent to the reader that at any given time, it is the case that one of the LCD viewing structures is substantially transparent and the other is substantially opaque such that when viewing the video display, the viewer can only view the same with one of their eyes.

The video display is provided by a series of frames of video shown in rapid succession. In order to generate the 3-dimensional view, the frames are shown in a known predefined format such as alternate right and left frames or alternatively the frames are shown at twice the normal rate and two right hand frames are followed by two left hand frames and so on, in sequence. The right hand video images need to be viewed by the viewer's right eye, and the left hand video images need to be viewed by the viewer's left eye and therefore the sequential operation of the viewing structures 16, 18 needs to be in synchronisation with the left and right hand images being shown on the video display.

This can be achieved, initially, as soon as the first predefined frame is detected by the viewing apparatus.

In accordance with the present invention there is provided a means whereby the loss of synchronicity can be avoided or, at least, detected quickly. This is achieved by providing, in the embodiment in the viewing device, at least one optical sensor 24 typically mounted in the arm of the glasses. A tube of appropriate dimensions to the viewing conditions can be used to give a narrow field of view to the sensor. The sensor is connected to control means for operation of the LCD mechanisms either by wire (not shown) or remotely. The optical sensor is mounted on the viewing device 6 such that when the viewing device is being used to look at the video display, the optical sensor is also directed towards the said video display. In conjunction with this, the sequence of video image frames which are generated, include, at spaced intervals, a predefined image 26 which is of a known format in this case as shown in FIG. 4 a substantially blank screen with two “white” lines 28. The said predefined image frame can be displayed at a particular frequency such as, for example, a said predefined image frame is displayed every 25 or more frames of either the right or left hand image. The image selected to be displayed is chosen so as to be distinguishable by the optical sensor and, upon the display of that image frame, and the detection of the same by the sensor, the control means for the viewing device will know which particular viewing configuration the viewing device should be in, i.e. which viewing structure should be transparent and which structure should be opaque. The control means will then check the condition or timing synchronisation of the viewing device with the individual frame on the display screen and, if in the required synchronisation, no further action will be taken. However, if the synchronisation is not what it should be when the predefined image is displayed and detected, a suitable alteration to the viewing structure control will be made. In one embodiment an adjustment mechanism is provided to allow small adjustments to the phase of the LCD screens activations. The same mechanism or a further mechanism can be provided to switch completely the synchronisation between the LCD screens of the left and right viewing structures. Furthermore, the control means can also calculate suitable adjustments to the operation for each of the viewing structure LCD mechanism so as to maintain synchronicity thereafter.

It should be appreciated that the control elements of this invention can be utilised successfully with other forms of viewing structures in the device which do not utilise the LCD mechanisms described herein.

The present invention therefore provides an effective viewing device and viewing system for 3-dimensional video image displays and which ensures that synchronicity between the viewing device and the video images is maintained without the requirement of wired, IR or RF links to the display or its associated components.

The device and system in accordance with the invention therefore provide many benefits, including low cost of manufacture, relatively low power demands and light weight for ease of use. From a technical viewpoint the ability for synchronisation allows the viewing device to cope with poorly edited video source material where the right and left hand images are out of sequence, particularly after multiple edit sessions. Furthermore as there are no connections and no particular distance constraints, the range of use of the viewing device is significantly greater than the conventional devices.

1. A viewing device for viewing a video display on a display screen which display includes the sequential display of right and left video images, said viewing device including first and second, spaced, viewing structures, such that a first viewing structure is positioned in front of the viewer's left eye and a second viewing structure is positioned in front of the viewer's right eye with the viewer being required to look through the structures to view the video display, each structure provided to be operable to change between a viewing condition and a masking condition and characterised in that a feature of a predefined format is displayed in the sequence of video images which can be detected to allow synchronisation of the operation of the viewing structures and the display of the images on the display screen.

2. A viewing device according to claim 1, characterised in that the feature is subliminal.

3. A viewing device according to claim 1, characterised in that each viewing structure construction is a screen which is configurable between substantially opaque and transparent conditions.

4. A viewing device according to claim 1, characterised in that the viewing device or associated components may be powered by any or any combination of batteries, mains power, and/or the like.

5. A viewing device according to claim 1, characterised in that the viewing device is capable of being worn.

6. A viewing device according to claim 1, characterised in that the feature is a substantially black image with a predefined marking element, and/or an overlying reference element.

7. A viewing device according to claim 6, characterised in that the reference element is located in a corner of the image.

8. A viewing device according to claim 6, characterised in that the reference element is any combination of colours and/or shapes to distinguish between left and white images.

9. A viewing device according to claim 6, characterised in that the image of predefined format replaces the right or left hand image of a video stereo pair.

10. A viewing device according to claim 1, characterised in that the feature is generated at adjustable time intervals.

11. A viewing device according to claim 1, characterised in that at least one viewing structure is provided with an optical sensor to detect the display of the feature.

12. A viewing device according to claim 11, characterised in that the optical sensor is a photodiode.

13. A viewing device according to claim 11, characterised in that the optical sensor is detachably mounted to the viewing device by any or any combination of reusable adhesive, clamps, grips, clips, screws, hook and loop fastenings, and/or the like.

14. A viewing device according to claim 11, characterised in that the optical sensor is provided with a housing which is configured to ensure that the optical sensor is automatically positioned so as to directly face the display screen.

15. A viewing device according to claim 11, characterised in that the optical sensor includes focusing means to focus or direct the light generated by the display screen onto the optical sensor and/or reduce the field of view of the optical sensor to eliminate or reduce the possibility of adverse light effects provided by any other light sources.

16. A viewing device according to claim 11, characterised in that the optical sensor scans a greater area than the area defined by the feature.

17. A viewing device according to claim 11, characterised in that the optical sensor includes control means, producing a control signal in response to detection of the feature, to control the viewing structures.

18. A viewing device according to claim 11, characterised in that the viewing device includes communication means for allowing communication between the optical device and other components of the viewing device.

19. A viewing device according to claim 18, characterised in that the communication means includes any or any combination of wires, optical means, radio frequencies, infra-red, and/or the like.

20. A viewing device according to claim 17, characterised in that the control signal is used to identify a right or left image to allow synchronisation of the viewing structures to the images.

21. A viewing device according to claim 17, characterised in that the control signal is used to determine the display rate of each successive video image and control the activation timing and frequency of the viewing structures.

22. A viewing device according to claim 17, characterised in that the control means act in a predictive and self-correcting manner to determine the activation timing and frequency of the viewing structures.

23. A viewing device according to claim 17, characterised in that the control means include adjustment means to allow fine manual and/or automatic adjustment of the same.

24. A viewing device according to claim 23, characterised in that the adjustment means are in the form of one or more wheels for rotation by a user.

25. A viewing device for viewing a sequential display of right and left video images to generate a three dimensional effect, said viewing device including first and second, spaced, viewing structures such that, in use, a first viewing structure is positioned in front of the viewer's left eye and a second viewing structure is positioned in front of the viewer's right eye with the viewer being required to look through the structures to view the video display, each structure provided with an LCD screen and control means to change the LCD screen between substantially transparent and substantially opaque conditions and wherein at least one feature of a predefined format is displayed and is of a form which can be detected by a sensor and allows synchronisation of the viewing device operation with the display of the images on the display screen.

26. A method for viewing a series of left and right video images to create to the user a three-dimensional effect, said method comprising the steps of;
generating a sequence of left and right video images on a display screen;
placing a viewing device between the user's eyes and the display screen, said device including viewing structures for the user's left and right eye respectively;
operating each of the viewing structures to move between open and masked conditions to allow selective viewing of the video images in sequence with the display of the same; and
wherein the video images include at least one feature of a predefined format which can be detected by a sensor and, when detected, the same is used to check and, if required, alter the synchronicity between the operation of the viewing structures and the display of the video images.
